(19) United States
(12) Patent Application Publication
(10) Pub. No.: US 2023/0259741 A1
(43) Pub. Date: Aug. 17, 2023

(54) METHOD AND APPARATUS FOR CONSTRUCTING DOMAIN ADAPTIVE NETWORK

(71) Applicant: Electronics and Telecommunications Research Institute, Daejeon (KR)

(72) Inventors: Joong Won HWANG, Daejeon (KR); Yong Jin KWON, Daejeon (KR); Jin Young MOON, Daejeon (KR); Yu Seok BAE, Daejeon (KR); Sung Chan OH, Daejeon (KR)

(73) Assignee: Electronics and Telecommunications Research Institute, Daejeon (KR)

(21) Appl. No.: 18/090,211

(22) Filed: Dec. 28, 2022

(30) Foreign Application Priority Data
Feb. 14, 2022 (KR) 10-2022-0018857

(51) Int. Cl. G06N 3/045; G06N 3/09

(52) U.S. Cl. CPC G06N 3/045; G06N 3/09

(57) ABSTRACT

The present disclosure relates to a method and apparatus for constructing a network adaptable to consecutive/complex domains. An apparatus for constructing a domain adaptive network according to an embodiment of the present disclosure includes a memory configured to store data; and a processor configured to control the memory, wherein the processor is configured to determine a weight to be applied to one or more neural networks based on input data, construct a final neural network by applying the weight to the one or more neural networks, and output result data of the input data using the final neural network, wherein the one or more neural networks are trained using data for each prototype domain.

### CROSS-REFERENCE TO RELATED APPLICATION

This application claims priority to and the benefit of Korean Patent Application No. 10-2022-0018857, filed on Feb. 14, 2022, the disclosure of which is incorporated herein by reference in its entirety.

### BACKGROUND

### 1. Field of the Invention

The present invention relates to a method and apparatus for constructing a network adaptable to consecutive/complex domains.

### 2. Discussion of Related Art

Under the topic of the 4th Industrial Revolution, technologies such as artificial intelligence, big data, the Internet of Things, and cloud computing are widely used. Here, artificial intelligence (AI) is a technology that focuses on solving cognitive problems primarily linked to human intelligence, such as learning, problem solving, pattern recognition, etc. With the recent improvement in computing efficiency, AI-based computer vision technology has also evolved.

Computer vision technology is a technology that uses an image as an input and performs tasks such as recognition conducted by humans. Currently, computer vision technology based on a deep neural network structure is widely used.

Learning of a deep neural network is generally performed in a way of modeling the real world through a large amount of learning data. Accordingly, when an environment in which the learning data is collected and an environment in which the neural network is actually used differ, the trained model and the operating environment do not match, resulting in a reduction in the performance of the neural network. Therefore, it is necessary to perform learning by matching the learning data with the operating environment, or to perform domain adaptive learning in which additional learning is added so that the already trained network adapts to the operating environment.

Meanwhile, there may be cases in which the deep neural network must be used in various environments. For example, the deep neural network that drives self-driving cars must work well in all environments, including weather conditions, light and dark times and locations. To this end, when learning data is collected from various environments to train the deep neural network, performance in the corresponding individual environment is lower than that when only one individual environment is learned.

Therefore, in order to build a system for exhibiting high performance in various environments, it may be necessary to use a neural network that has learned data tailored to each environment or has performed domain adaptive learning.

However, in the case of using a neural network that has learned only data tailored to each environment, the number of required domain-specific neural networks increases proportionally as the expected number of domains increases. In particular, when building the domain-specific neural network, a process of collecting separate learning data for each neural network, a process of performing learning, a process of selecting a network, and a process in which the network is actually used are required, so that the burden of time and resources are increased in all processes.

In addition, since the definition of the domain is segmented, it may be difficult to select which neural network to use between the segmented definitions. For example, assuming that there is a neural network trained with data collected in a dark night environment and a neural network trained with data collected in a bright day environment, it becomes difficult to determine which neural network should be used in the dusky evening when the sun goes down. In addition, even if the neural network learns each domain, such as a rainy environment and an evening environment, the same problem also occurs when a complex situation such as a rainy evening occurs. To this end, when the neural network for the evening environment is additionally trained in addition to the neural network for the rainy environment, a problem arises that increases the burden of time and resources again.

### SUMMARY OF THE INVENTION

The present invention is directed to a method and apparatus for constructing a network adaptable to consecutive/complex domains.

In addition, the present invention is directed to a domain-adaptive network construction technology that alleviates the burden of time and resources.

In addition, the present invention is directed to a technique for changing the parameter state of a deep neural network so that a system using the deep neural network may respond to various/continuous environmental changes.

In addition, the present invention is directed to a technique for establishing adaptive performance even in a non-predefined domain by combining one or more neural networks.

Other objects and advantages of the present disclosure can be understood by the following description, and will be more clearly understood by the embodiments of the present disclosure. Furthermore, it will be readily apparent that the objects and advantages of the present disclosure may be realized by means of the instrumentalities and combinations thereof set forth in the claims.

According to an aspect of the present disclosure, there is provided an apparatus for constructing a domain adaptive network including a memory configured to store data, and a processor configured to control the memory, wherein the processor may be configured to determine a weight to be applied to one or more neural networks based on input data, construct a final neural network by applying the weight to the one or more neural networks, and output resultant data for the input data using the final neural network, wherein the one or more neural networks may be trained using data for each prototype domain.

In addition, the input data may be data associated with one or more prototype domains.

In addition, the one or more neural networks may all have the same structure.

In addition, the one or more neural networks may be stored in a neural network pool, and the neural network pool may be compressed through a singular vector decomposition (SVD) technique.

In addition, the weight may be in the form of a vector.

In addition, the final neural network may be derived based on a linear combination of parameters of the one or more neural networks using the weight.

In addition, the one or more neural networks may be derived based on a primitive neural network trained on the prototype domain.

In addition, the primitive neural network may be trained through supervised learning or representation learning.

In addition, the weight may be derived based on a multilayer neural network, and the multilayer neural network may be trained based on a weighted sum of results of the one or more neural networks.

According to another aspect of the present disclosure, there is provided an apparatus for constructing a domain adaptive network including a memory configured to store data and a processor configured to control the memory, wherein the processor may be configured to collect learning data associated with one or more prototype domains, and perform multilayer neural network learning to determine a weight to be applied to one or more neural networks using the collected learning data.

In addition, the weight may be derived to combine result values of the one or more neural networks.

In addition, the multilayer neural network learning may be based on a weighted sum of the one or more neural networks and a cross entropy loss function of GT-Label.

In addition, the multilayer neural network learning may be performed based on a knowledge distillation method.

In addition, the multilayer neural network learning may be based on a weighted sum of the one or more neural networks and a cross entropy loss of GT-Label as a loss function.

The learning data may be generated by a mixup method of adjusting a ratio of data to the prototype domain.

According to another aspect of the present disclosure, there is provided a method of constructing a domain adaptive network including determining a weight to be applied to one or more neural networks; acquiring a final neural network by applying the weight to the one or more neural networks; and outputting a result of input data using the final neural network, wherein the one or more neural networks may be trained using data for each prototype domain.

In addition, the input data may be data associated with one or more prototype domains.

In addition, the one or more neural networks may all have the same structure.

In addition, the one or more neural networks may be stored in a neural network pool, and the neural network pool may be compressed through a singular vector decomposition (SVD) technique.

In addition, the weight may be in the form of a vector.

In addition, the final neural network may be derived based on a linear combination of parameters of the one or more neural networks using the weight.

In addition, the one or more neural networks may be derived from a primitive neural network trained on the prototype domain.

According to an embodiment of the present disclosure, it is possible to construct a network adaptable to consecutive/complex domains.

In addition, according to an embodiment of the present disclosure, it is possible to alleviate time and resource loads by configuring a domain adaptive network.

In addition, according to an embodiment of the present disclosure, it is possible to change the parameter state of a multilayer neural network to respond to various/consecutive environmental changes.

In addition, according to an embodiment of the present disclosure, it is possible to establish adaptive performance even in a non-predefined domain by combining one or more neural networks.

The effects obtainable in the embodiments of the present disclosure are not limited to the above-mentioned effects, and other effects that are not mentioned may be clearly derived and understood by those skilled in the art to which the technical configuration of the present disclosure applies from the following description of the embodiments of the present disclosure. That is, unintended effects according to implementation of the present disclosure can also be derived by those skilled in the art from embodiments of the present disclosure.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a system for constructing a domain adaptive network according to an embodiment of the present disclosure;

FIG. 2 is a flowchart illustrating a method for constructing a domain adaptive network according to an embodiment of the present disclosure;

FIG. 3 is a diagram illustrating a neural network pool according to an embodiment of the present disclosure;

FIGS. 4 and 5 are diagrams illustrating compression of a neural network pool according to an embodiment of the present disclosure;

FIG. 6 is a diagram illustrating a combiner for constructing a domain adaptive network according to an embodiment of the present disclosure;

FIG. 7 is a diagram illustrating complex/consecutive domain learning according to an embodiment of the present disclosure;

FIG. 8 illustrates a final neural network that is a domain adaptive network according to an embodiment of the present disclosure;

FIG. 9 is a diagram illustrating a method for constructing a domain adaptive network according to an embodiment of the present disclosure;

FIG. 10 is a diagram illustrating a method for constructing a domain adaptive network according to another embodiment of the present disclosure; and

FIG. 11 is a diagram illustrating an apparatus for constructing a domain adaptive network according to an embodiment of the present disclosure.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, in describing the embodiments of the present disclosure, a network may be used interchangeably with a neural network, a model, and the like.

Hereinafter, in describing the embodiments of the present disclosure, the present disclosure will be described in detail with reference to the drawings.

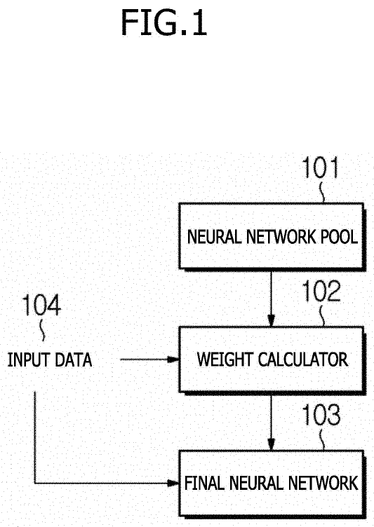

FIG. 1 is a diagram illustrating a system for constructing a domain adaptive network according to an embodiment of the present disclosure.

As an example, the system for constructing a domain adaptive network may include a neural network pool 101, a weight calculator 102, and a final neural network 103. Input data 104 may be input to the weight calculator 102 and the final neural network 103.

One or more neural networks may be included in the neural network pool 101. As an example, one or more neural networks may each have been completely trained, and in the one or more neural networks, learning has been performed using data for a prototype domain. Here, the prototype domain may refer to a domain in which a large amount of data is secured to the extent that learning is possible, which is defined in advance before learning. For example, the prototype may vary depending on the characteristics of the input data, but may be, when the input data is image data, distinguished and determined according to weather (rainy day, sunny day, partly cloudy day, cloudy day, etc.), time zone (noon, evening, etc.), etc. Each of the one or more neural networks may be a multilayer neural network and may include a hidden layer or the like. In addition, the neural networks present in the neural network pool may all have the same structure. Each of the neural networks may be a neural network that exhibits performance specific to each prototype domain, or may have a compressed form of such neural networks.

For example, the weight calculator 102 is an object that serves to determine how to deal with a combination of weights according to the input data according to circumstances, and may be included in a combiner or an apparatus for constructing an adaptive network. In addition, the weight calculator 102 may determine weights to be applied to the one or more neural networks included in the neural network pool 101 to determine the final neural network 103 when the input data 104 is received. For example, the weight may be determined for all the neural networks included in the neural network pool, but it is also possible for the weight calculator to select some of the neural networks to be used in the neural network pool based on the input data and then determine the weights to be applied to the selected neural networks. Other methods are also possible. That is, the present disclosure is not limited thereto. As an example, the weight may be defined in the form of a vector and applied to parameters of the one or more neural networks, and the weight calculator 102 may be a multilayer neural network trained to determine optimal weights. When the weight is applied, the final neural network 103 may be generated, and the final neural network may have the same structure as the one or more neural networks included in the neural network pool. That is, for example, the final neural network may be a neural network having the same structure using a value of a linear combination of the parameters of the neural networks present in the neural network pool as a parameter. The final neural network may be generated by changing the parameter state of the multilayer neural network through a parameter averaging method.

For example, the final neural network 103 may be configured based on the weight calculated by the weight calculator 102. The final neural network 103 may receive the input data 104 to output result data or to perform prediction. Performing prediction may include, for example, pattern recognition, character recognition, and the like, but the present disclosure is not limited thereto.

The neural network pool 101, the weight calculator 102, the final neural network 103, and the input data 104 will be described in detail below with reference to other drawings.

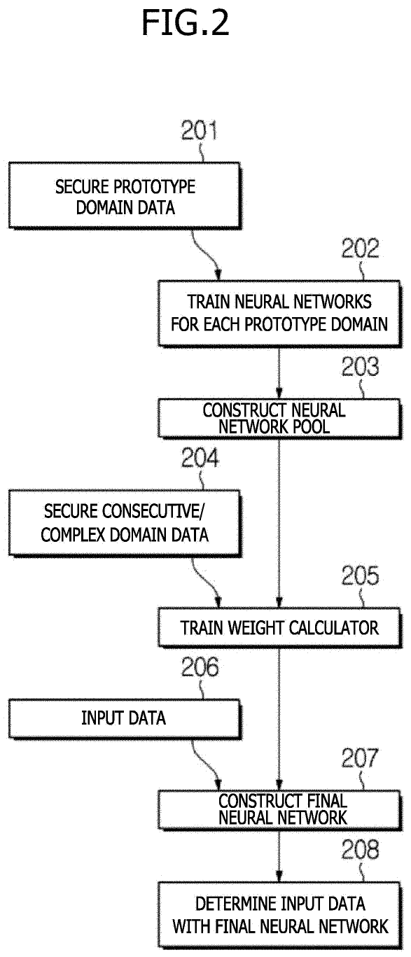

FIG. 2 is a flowchart illustrating a method for constructing a domain adaptive network according to an embodiment of the present disclosure.

As an example, a method for learning and constructing a domain adaptive network of FIG. 2 may be performed by the system of FIG. 1 or an apparatus for constructing a domain adaptive network to be described below.

As an example, in operation 201, prototypical domain data may be acquired for learning and constructing a domain adaptive network. Learning data may be collected to the extent that learning can be performed for each prototype domain. Here, the learning data may be video data or audio data, and is not limited to any one type of data.

Based on the secured prototype domain, in operation 202, a neural network may be trained for each prototype domain. That is, one or more neural networks for each of one or more prototype domains may be prepared. The structure of the neural network (e.g., CNN or LSTM) or learning method (e.g., knowledge distillation, supervised learning, etc.) is not limited in the present disclosure. In this case, each neural network may be trained using different prototype domain data based on the same primitive neural network, so that each neural network may have the same structure, but the present disclosure is not limited thereto. When the neural network for each domain is trained, the trained neural network may be used to construct a neural network pool in operation 203. That is, one or more neural networks may be included in the neural network pool.

Meanwhile, after constructing the neural network pool, a process of determining the weight to be applied to each neural network using a weight calculator may be performed. Before the weight calculator determines the weight, the weight calculator may determine the weight in various ways, but as an example among the various ways, an example in which a weight calculator is also composed of a multi-layer neural network and has been trained will be described in detail. However, the present disclosure is not limited thereto.

As an example, in operation 204, learning data including consecutive/complex domain data may be secured for learning of a weight calculator that is a multi-layer neural network. The consecutive/complex domain data refers to data associated with one or more prototype domains. As an example, when the multilayer neural network is for image processing and the input data is image data, data associated with only one prototype may be an image of a rainy day, and data associated with one or more prototypes may be a rainy and thunder/lightning day, or the like. A plurality of pieces of consecutive/complex domain data may be collected for training the weight calculator, but the learning data may not necessarily include only consecutive/complex domain data. That is, the learning data may include various types of data without limitation of data types. Using this, the weight calculator may be trained in operation 205. As an example, the weight calculator may have the same structure as the neural network of the neural network pool. However, the present disclosure is not limited thereto, and the learning method of the weight calculator is not limited thereto.

Meanwhile, in FIG. 2, although the process for training the weight calculator is necessarily performed after the process for constructing the neural network pool, this is for clarity of explanation, the processes can be performed simultaneously, and it is not intended to limit any order.

When learning of the weight calculator is completed, the weights to be applied to one or more neural networks in the neural network pool may be determined based on input data 206. That is, the weight calculator may determine the weight according to the input data 206, and the weight may be determined for all the neural networks included in the neural network pool or for some neural networks. In addition, the input data 206 may be associated with one or more prototype domains. That is, the input data 206 may be associated with only one prototype domain, but the input data 206 may be also data having consecutive/complex prototype domains. When the weight is determined by the weight calculator through the input data 206, in operation 207, the final neural network may be constructed by applying each weight to one or more neural networks. The determined weight may be applied to the results of the one or more neural networks, etc., but may be applied to parameters of the one or more neural networks to derive the final neural network. When the final neural network is constructed, in operation 208, the final neural network may receive the input data 206 to determine the input data with the final neural network, and may output result data based on the determined input data. The result data may vary depending on the working purpose of the final neural network. For example, results of pattern recognition, character recognition, etc., may be derived and results obtained by performing prediction may appear.

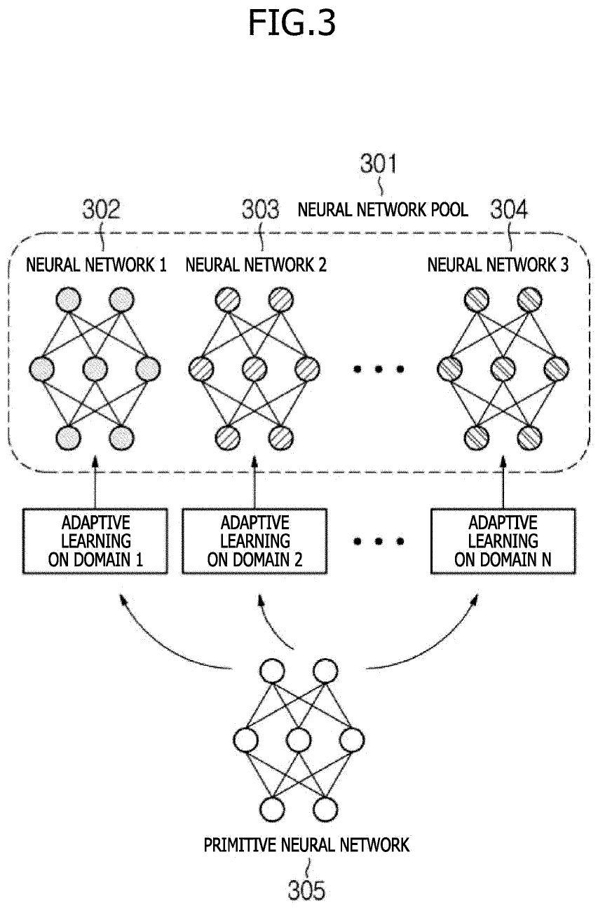

FIG. 3 is a diagram illustrating a neural network pool according to an embodiment of the present disclosure. As an example, FIG. 3 illustrates an example of a neural network pool that may include one or more of the above-mentioned neural networks that have been completely trained.

As an example, theoretically, since the parameter averaging method is a method of averaging a plurality of similar parameters, when the above-mentioned weight calculator calculates a weight based on a parameter and uses the parameter averaging method, it may be necessary to keep the parameter values of the neural networks in the neural network pool similar. In this case, the amount of data per each prototype domain itself may be insufficient.

Considering this situation, one primitive neural network is trained in advance using data that is considered general data, such as ImageNet or MSCOCO, or data without labels, or data from all domains, and using this, it is possible to derive the neural network to be included in the neural network pool. In this case, a process of adapting the parameters of the primitive neural network for each domain using initial values may be performed. Learning of the primitive neural network may be performed through supervised learning or through a representation learning method such as MOCO or Simclr, but there is no limit to the learning method. That is, one or more neural networks to be included in the neural network pool may be derived by adjusting the parameters of the primitive neural network trained based on various types of data.

As another example, it may be possible to omit this process according to a desired result or the amount of corresponding data, and directly train the neural network for each domain individually.

In addition, as another example, it is also possible to derive the one or more neural networks by first training the primitive neural network with various types of data and then additionally learning data for each prototype domain in the primitive neural network. That is, additional learning is performed on each neural network. In this way, the neural networks in the neural network pool adapted for each domain may have performance specific to each domain.

Meanwhile, when the neural network pool is constructed, there is a method of producing the neural network pool using a singular vector decomposition (SVD) technique. When the range of the prototype domain to be covered is very wide, the parameters of the neural network may be compressed using the SVD technique and expressed as a combination of a smaller number of singular vectors. This will be described in more detail below with reference to other figures.

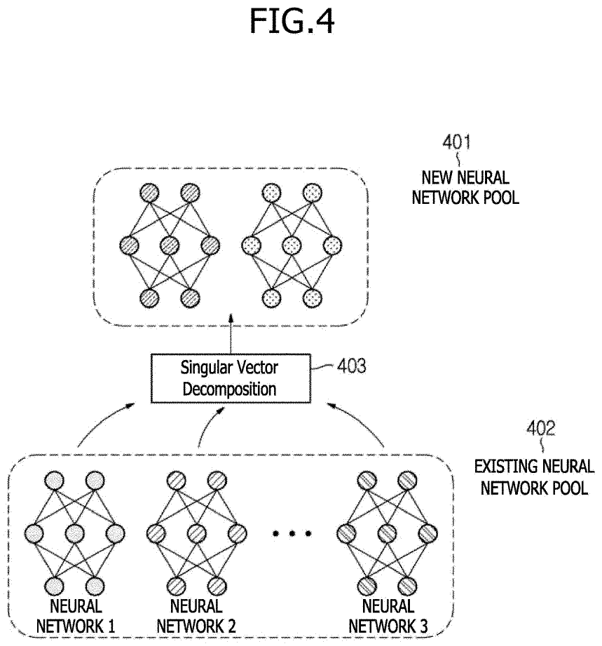

FIGS. 4 and 5 are diagrams illustrating compression of a neural network pool according to an embodiment of the present disclosure. More specifically, FIGS. 4 and 5 are diagrams illustrating a process of compressing a neural network pool through the SVD technique.

As an example, an existing neural network pool, that is, a neural network pool 402 including one or more neural networks may include one or more neural networks on which parameter compression is not performed. This may have a form 501 in which the parameters of the neural networks included in the neural network pool are converted into column vectors and stacked. Thereafter, SVD 403 may be performed to configure the neural network parameters as a left singular value 502, a singular value 503, and a right singular value 504. As an example, after extracting a certain number of left singular vectors 502 based on the singular values, a network using these left singular values or their span values as parameters may be used as an element of the neural network pool to construct a new neural network pool 401. This may be similar to the process of producing an eigenface in a facial recognition system.

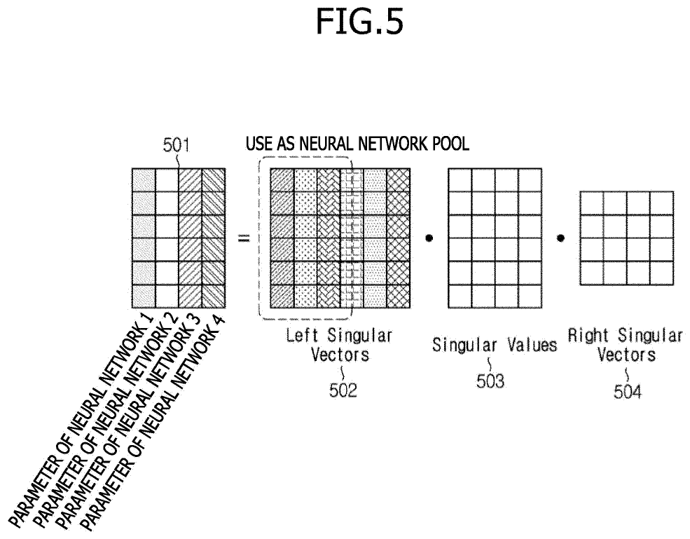

FIG. 6 is a diagram illustrating a combiner for constructing a domain adaptive network according to an embodiment of the present disclosure.

As an example, a combiner may be included in a weight calculator as mentioned above, or may be a weight calculator and may be included in an apparatus for constructing a domain adaptive network or the like.

FIG. 6 is a diagram illustrating an implementation and learning method of a combiner to which an attention technique is applied as an example. As an example, for clarity of explanation, it is assumed that the combiner is also composed of a multilayer neural network and receives an image.

As an example, the input of the combiner may include result values of neural networks, intermediate result values of hidden layers, input images, weather information, time/location information, and the like, but is not limited thereto. As an example, the combiner may have learned how to give attention to each result of the neural networks included in the neural network pool using an attention technique.

The combiner 604 may calculate a weight to be added to the neural networks present in the neural network pool according to input data. As an example, the combiner may calculate the weight in the form of a weight vector 605, which may be for one or more neural networks 601, 602, and 603, and the one or more neural networks may be included in the neural network pool.

The combiner learning method is not limited, but may be performed, for example, using a weighted sum of results rᵢ of the neural networks belonging to the neural network pool and a cross entropy loss of GT-Label as a loss function. That is, in a state in which the result rᵢ of each neural network is determined, α=[α₁, α₂, . . . α_{N}] which minimizes a difference between y which is ground truth and

$$\hat{y} = \frac{1}{\sum {α}_{i}} {\sum }_{i} {α}_{i} {r}_{i}$$

which is a weighted sum may be obtained, and the combiner may be implemented in such a manner to be trained through backpropagation so that an output close to α is produced with respect to a given input image, that is, input data.

However, this is just one embodiment, and the combiner may be constructed through a method of using a system other than a neural network for a combiner, a method of obtaining an input of a combiner as metadata such as time, location, weather information, etc., other than images, a method of applying knowledge distillation using results of other networks instead of GT-Label, a method of using a function other than cross entropy as a loss function, and the like, but the present disclosure is not limited thereto.

According to the present disclosure, the combiner performs learning to output a weight vector for combining result values of all or some neural networks included in the neural network pool, and the derived weight vector may be used for combining parameters of all or some of the neural networks included in the neural network pool.

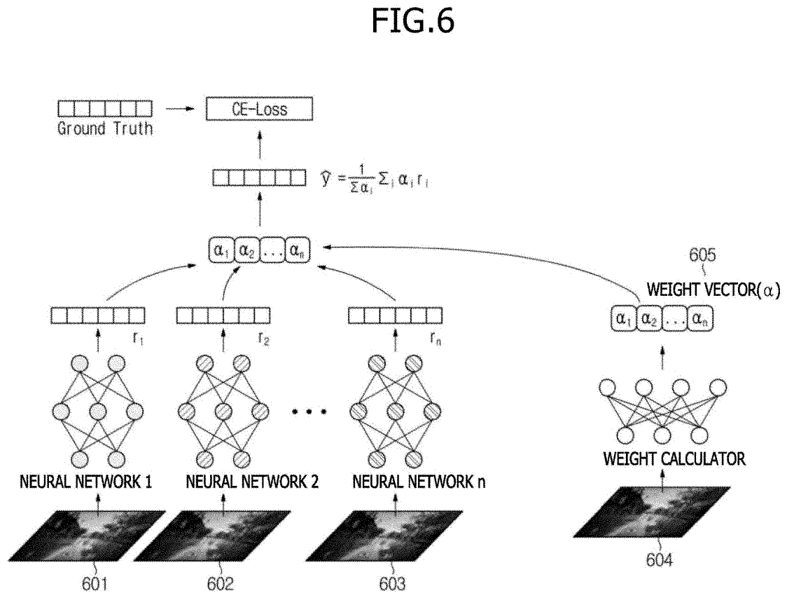

FIG. 7 is a diagram illustrating complex/consecutive domain learning according to an embodiment of the present disclosure.

More specifically, FIG. 6 is one of the embodiments of a method of securing data for learning consecutive domains, that is, one or more domains and a learning method of a combiner.

As an example, the combiner may use synthetic data generated using a well-known GTA-5 or foggy cityscape data generator as training data. That is, various types of synthetic data may be generated using a synthetic data generator 701.

As an example, as mentioned above, when the neural network is to be trained as a neural network that performs image-related processing, a change 702 may be made to information included in the image, that is, environmental elements such as rainfall, an amount of sunlight, and the degree of fog. That is, synthetic data may be generated by changing the weather, time zone, etc., of the image. Each of these environmental elements may be treated as a separate prototyping domain, respectively.

One or more various types of image data including the above synthetic data may be collected in operation 703, but the image data does not necessarily include only synthetic data. The image data may be used for training the combiner in operation 704 and may have a sufficient amount for training.

This method is significant in enabling the combiner to learn how to operate in complex domains and consecutive domain changes.

Meanwhile, instead of using such synthetic data, a mixup method of adjusting the ratio of each prototype or a method of directly obtaining and learning data of consecutive domains may also be used, and the present disclosure is not limited to this.

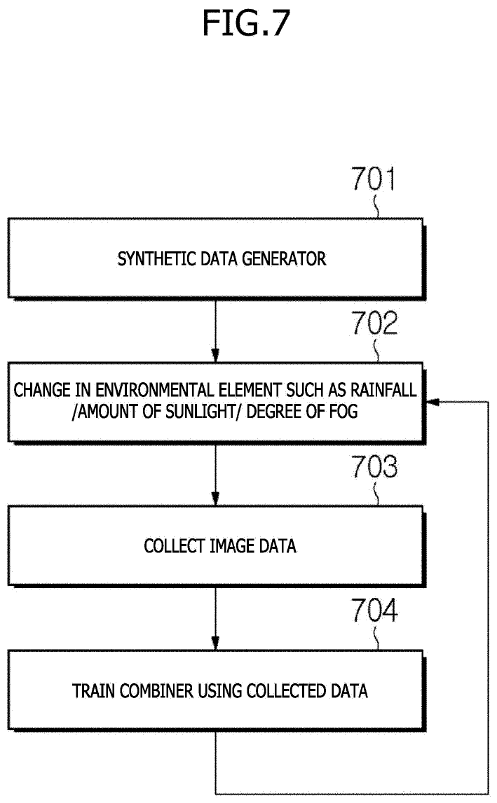

FIG. 8 illustrates a final neural network that is a domain adaptive network according to an embodiment of the present disclosure.

As an example, for clarity of explanation, as mentioned above, it is assumed that a neural network pool including one or more neural networks 801, 802, and 803 is present, a weight calculator 804 that has been completely trained for determining weights for one or more neural networks is present, and a weight vector 805 of input data has been determined.

The determined weight is applied to the one or more neural networks, through which a final neural network 806 may be derived. The combiner outputs a weight vector 805 based on the input data (e.g., images), and the final network may be constructed by weighting and summing the parameters of some or all of the neural networks of the neural network pool according to the weight vector 805.

In a learning process of each neural network, an input passes through all the neural networks belonging to the neural network pool to produce a result, but in the execution stage, prediction is performed by passing through the final neural network only once. This may be based on the stochastic weight average principle in which a network with parameter averaging can output an average value of network results.

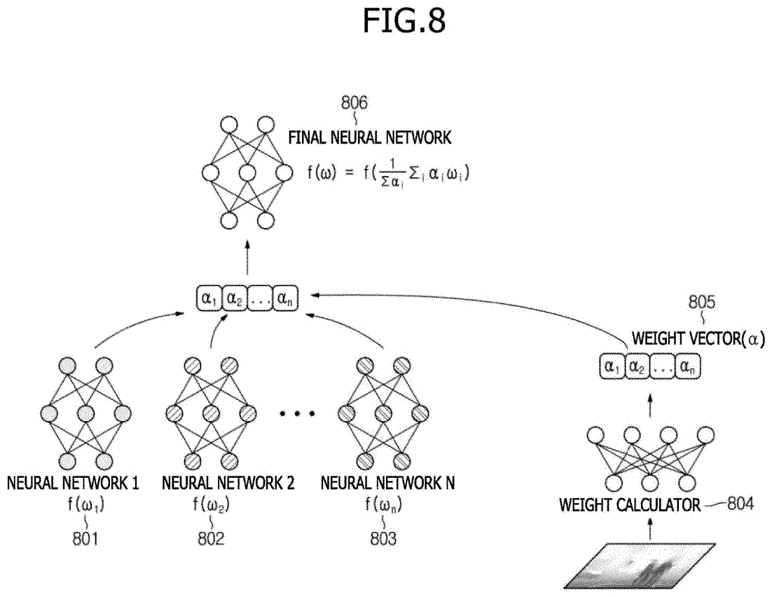

FIG. 9 is a diagram illustrating a method for constructing a domain adaptive network according to an embodiment of the present disclosure.

As an example, the method for constructing a domain adaptive network of FIG. 9 may be performed by a combiner, a weight calculator, an apparatus for constructing a domain adaptive network, or a system for constructing a domain network, but may also be performed by other devices and systems depending on circumstances. The present disclosure is not limited thereto.

As an example, a weight to be applied to one or more neural networks may be determined in operation S901. One or more neural networks may determine weights according to input data. The one or more neural networks may be included in a neural network pool and may be trained using data for each prototype domain. The structure or learning method of the one or more neural networks is not limited, but as an example, the one or more neural networks may all have the same structure. Meanwhile, when the one or more neural networks are included in the neural network pool, the neural network pool may be compressed through the SVD technique, as described above. As an example, the weight may be in the form of a vector, and may be applied to results or parameters of the one or more neural networks. As an example, the one or more neural networks may correspond to all or some of the neural networks included in the neural network pool. Determination of the weight may be based on a trained multilayer neural network. Meanwhile, the one or more neural networks may be individually trained for the prototype domain, but the parameters may be adjusted based on the primitive neural network trained for the prototype domain, or additional learning may be performed for each domain. In addition, the primitive neural network may be trained through supervised learning or representation learning as described above. In addition, the weight may be derived based on the multilayer neural network, and the multilayer neural network may be trained based on a weighted sum of results of the one or more neural networks.

When the weight is determined, the determined weight may be applied to the one or more neural networks to obtain a final neural network in operation S902. As an example, when the weights are applied to the parameters of the one or more neural networks, the final neural network may be derived based on a linear combination of the parameters of the one or more neural networks using the weights, and may be derived based on the weights determined according to input data as described above.

Next, the result of the input data may be output using the final neural network in operation S903. Prediction is performed on the input data, and result data is output.

Meanwhile, since FIG. 9 corresponds to an embodiment of the present disclosure, the order of FIG. 9 may be changed or some operations may be added/deleted.

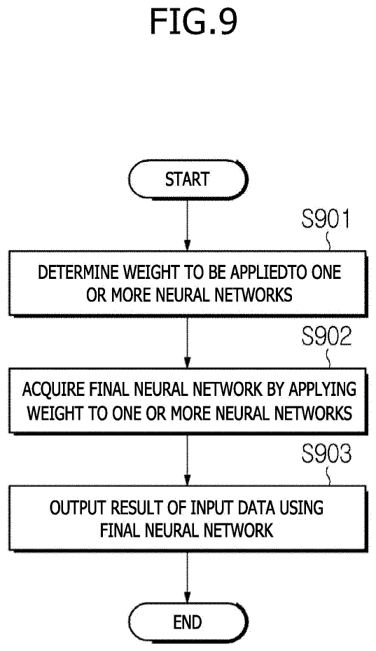

FIG. 10 is a diagram illustrating a method for constructing a domain adaptive network according to another embodiment of the present disclosure. More specifically, FIG. 10 relates to a learning method of a weight calculator for constructing a domain adaptive network.

As an example, the method of constructing a domain adaptive network of FIG. 10 may be performed by an apparatus for constructing a domain adaptive network or a system for constructing a domain network, but may also be performed by other devices and systems according to circumstances, and the present disclosure is not limited thereto.

As an example, the method for constructing a domain adaptive network of FIG. 10 may be performed before constructing the domain adaptive network, but the method or apparatus for constructing a domain adaptive network of the present disclosure does not necessarily follow the constructing method of FIG. 10.

As an example, learning data associated with one or more prototype domains may be collected in operation S1001. Each piece of data may be associated with only one prototype domain, but it is also possible for one piece of data to be associated with more than one prototype domain, and the data may be collected in a sufficient amount for learning. Meanwhile, the learning data may be generated, and may be generated in the manner described with reference to FIG. 7. That is, as an example, the learning data may be generated by a mixup method of adjusting the ratio of data to the prototype domain.

Next, when the learning data is collected, multilayer neural network learning may be performed to determine weights to be applied to one or more neural networks using the collected learning data in operation S1002. The multilayer neural network learning may be performed based on the weighted sum of the one or more neural networks and the cross entropy loss of GT-Label as a loss function. In addition, the multilayer neural network learning may be performed based on a knowledge distillation method. Meanwhile, the weights may be derived to combine result values of the one or more neural networks during learning, but the weights derived at the time of use after learning of the multilayer neural network may be applied to the parameters of the one or more neural networks.

Meanwhile, since FIG. 10 corresponds to an embodiment of the present disclosure, the order of FIG. 9 may be changed or some operation may be added/deleted.

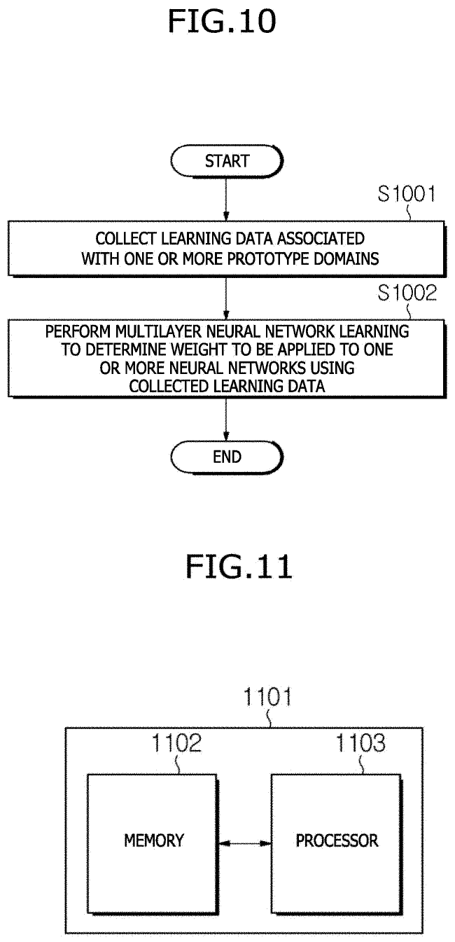

FIG. 11 is a diagram illustrating an apparatus for constructing a domain adaptive network according to an embodiment of the present disclosure.

As an example, the apparatus 1101 for constructing a domain adaptive network of FIG. 11 may include a memory 1102 configured to store data and a processor 1103 configured to control the memory, and although not shown, may further include a user input/output interface, a data transceiver, and the like as necessary.

As an example, the apparatus for constructing a domain adaptive network of FIG. 11 may perform a method for constructing a domain adaptive network, but does not necessarily have to perform processing in the order shown. In addition, the method including the method described above with reference to other drawings may be performed.

As an example, the processor 1103 may determine a weight to be applied to one or more neural networks based on input data, may construct a final neural network by applying the weight to the one or more neural networks, and may output result data of the input data using the final neural network, wherein the one or more neural networks may be trained using data for each prototype domain. As described above, the input data may be data associated with one or more prototype domains, but the one or more neural networks may all have the same structure. In addition, the one or more neural networks may be stored in a neural network pool, and the neural network pool may be compressed through an SVD technique. The weight may be in the form of a vector, and the final neural network may be derived based on a linear combination of parameters of the one or more neural networks using the weight. The one or more neural networks may be obtained by training a primitive neural network on the prototype domain, and the primitive neural network may be trained using a method such as supervised learning or representation learning. In addition, the weight may be derived based on a multilayer neural network, and the multilayer neural network may be trained based on a weighted sum of results of the one or more neural networks. However, the present disclosure is not limited thereto.

As another example, when the apparatus shown in FIG. 11 is the apparatus for constructing a domain adaptive network and an apparatus for performing weight learning for constructing a domain adaptive network, the processor 1103 may collect learning data associated with one or more prototype domains, and may perform multilayer neural network learning to determine a weight to be applied to one or more neural networks using the collected learning data. As an example, the multilayer neural network learning may be performed based on a weighted sum of the one or more neural networks and a cross entropy loss of GT-Label as a loss function, and the multilayer neural network learning may be performed based on a knowledge distillation method. In addition, the learning data may be generated by a mixup method that adjusts the ratio of data to the prototype domain. Meanwhile, the weight may be derived to combine result values of the one or more neural networks during learning, but the weight derived after learning may be applied to parameters of the one or more neural networks.

Meanwhile, based on the description of FIG. 11, it seems as if the uses are divided and described, but this is for clarity of explanation, and the present disclosure is not limited thereto. That is, the apparatus for constructing a domain adaptive network is not divided and may be implemented as one device. When the apparatus for constructing a domain adaptive network is implemented with only one device, the apparatus may or may not be functionally divided, and the same or one or more processors may perform domain adaptive network construction.

According to the present disclosure, there is no hassle of forwarding input data as many times as the number of networks belonging to the neural network pool in an operation of using the domain adaptive network, that is, the final neural network, thereby reducing the burden of time and resources. In addition, according to the generalization ability of the combiner, it may be expected that adaptive performance can be produced even in a domain that is not predefined.

Various embodiments of the present disclosure are intended to explain representative aspects of the present disclosure rather than listing all possible combinations, and details described in various embodiments may be applied independently or in combination of two or more.

In addition, various embodiments of the present disclosure may be implemented by hardware, firmware, software, or a combination thereof. In addition, various embodiments of the present disclosure may be implemented by a combination of one or more pieces of software rather than one piece of software, and one entity may not perform all processes. For example, a machine learning process that requires a high degree of data computing capability and a large amount of memory may be performed in a cloud or a server, and may be implemented in a manner the user uses only a neural network on which machine learning has been completed, but is not limited thereto.

For hardware implementation, the hardware may be implemented by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, or the like. For example, the hardware may have various forms including the general processor. It is obvious that it may be disclosed as hardware consisting of one or more combinations.

The scope of the present disclosure includes software or machine-executable instructions (e.g., operating system, applications, firmware, programs, etc.) that cause the operation according to the method according to various embodiments to be executed on a device or computer, and a non-transitory computer-readable medium in which such software or instructions are stored and executable on the device or computer.

As an embodiment, a program for constructing a domain adaptive network according to an embodiment of the present disclosure may be stored in a non-transitory computer-readable medium, may determine a weight to be applied to one or more neural networks in a computer, acquire a final neural network by applying the weight to the one or more neural networks, and output a result of input data using the final neural network.

As another embodiment, a program for constructing a domain adaptive network according to an embodiment of the present disclosure may be stored in a non-transitory computer-readable medium, may collect learning data associated with one or more prototype domains, and may perform multilayer neural network learning to determine a weight to be applied to one or more neural networks using the collected learning data.

Meanwhile, the content described with reference to each drawing is not limited to each drawing, and may be applied complementary to each other as long as there is no conflicting content. In the present disclosure described above, since various substitutions, modifications, and changes are apparent to those of ordinary skill in the technical field to which the present disclosure belongs without departing from the technical spirit of the present disclosure, the scope of the present disclosure described above is not limited by the foregoing embodiments and the accompanying drawings.

What is claimed is:

1. An apparatus for constructing a domain adaptive network, the apparatus comprising:
a memory configured to store data; and
a processor configured to control the memory, wherein
the processor is configured to determine a weight to be applied to one or more neural networks based on input data, construct a final neural network by applying the weight to the one or more neural networks, and output result data of the input data using the final neural network, and
the one or more neural networks are trained using data for each prototype domain.

2. The apparatus of claim 1, wherein the input data is data associated with one or more prototype domains.

3. The apparatus of claim 1, wherein the one or more neural networks all have the same structure.

4. The apparatus of claim 1, wherein the one or more neural networks are stored in a neural network pool, and the neural network pool is compressed through a singular vector decomposition (SVD) technique.

5. The apparatus of claim 1, wherein the weight is in the form of a vector.

6. The apparatus of claim 1, wherein the input data is data associated with one or more prototype domains.

7. The apparatus of claim 1, wherein the one or more neural networks are derived based on a primitive neural network trained on the prototype domain.

8. The apparatus of claim 7, wherein the primitive neural network is trained through supervised learning or representation learning.

9. The apparatus of claim 1, wherein the weight is derived based on a multilayer neural network, and the multilayer neural network is trained based on a weighted sum of results of the one or more neural networks.

10. An apparatus for constructing a domain adaptive network, the apparatus comprising:
a memory configured to store data; and
a processor configured to control the memory, wherein
the processor is configured to collect learning data associated with one or more prototype domains, and perform multilayer neural network learning to determine a weight to be applied to one or more neural networks using the collected learning data, and
the weight is derived to combine result values of the one or more neural networks.

11. The apparatus of claim 10, wherein the multilayer neural network learning is based on a weighted sum of the one or more neural networks and a cross entropy loss function of GT-Label.

12. The apparatus of claim 10, wherein the multilayer neural network learning is performed based on a knowledge distillation method.

13. The apparatus of claim 10, wherein the learning data is generated by a mixup method of adjusting a ratio of data to the prototype domain.

14. A method for constructing a domain adaptive network, the method comprising:
determining a weight to be applied to one or more neural networks;
acquiring a final neural network by applying the weight to the one or more neural networks; and
outputting a result of input data using the final neural network,
wherein the one or more neural networks are trained using data for each prototype domain.

15. The method of claim 14, wherein the input data is data associated with one or more prototype domains.

16. The method of claim 14, wherein the one or more neural networks all have the same structure.

17. The method of claim 14, wherein the one or more neural networks are stored in a neural network pool, and the neural network pool is compressed through a singular vector decomposition (SVD) technique.

18. The method of claim 14, wherein the weight is in the form of a vector.

19. The method of claim 14, wherein the final neural network is derived based on a linear combination of parameters of the one or more neural networks using the weight.

20. The method of claim 14, wherein the one or more neural networks are derived from a primitive neural network trained on the prototype domain.
